(19) United States
(12) Patent Application Publication
(10) Pub. No.: US 2022/0158487 A1
(43) Pub. Date: May 19, 2022

(54) SELF-ORGANIZING AGGREGATION AND COOPERATIVE CONTROL METHOD FOR DISTRIBUTED ENERGY RESOURCES OF VIRTUAL POWER PLANT

(71) Applicants: Hainan Electric Power School, Hainan (CN); Shanghai Jiao Tong University, Shanghai (CN); Shanghai Qianguan Energy Saving Technology Co., Ltd., Shanghai (CN)

(72) Inventors: Guangyu He, Haikou (CN); Huan Zhou, Haikou (CN); Jucheng Xiao, Haikou (CN); Qing Wu, Haikou (CN); Zhiyong Li, Haikou (CN); Jie Shao, Haikou (CN); Dihan Pan, Haikou (CN); Daolong Ning, Haikou (CN); Shulong Wen, Haikou (CN)

(73) Assignees: Hainan Electric Power School, Hainan (CN); Shanghai Jiao Tong University, Shanghai (CN); Shanghai Qianguan Energy Saving Technology Co., Ltd., Shanghai (CN)

(21) Appl. No.: 17/516,606

(22) Filed: Nov. 1, 2021

(30) Foreign Application Priority Data
Nov. 16, 2020 (CN) 202011278673.5

(51) Int. Cl. H02J 15/00; G06K 9/62; G06F 17/12; G06Q 50/06; H02J 3/32; G05B 15/02

(52) U.S. Cl. CPC H02J 15/00; G06K 9/6256; G05B 15/02; G06Q 50/06; H02J 3/322; G06F 17/12

(57) ABSTRACT

A self-organizing aggregation and cooperative control method for distributed energy resources of a virtual power plant is provided. According to the self-organizing aggregation and cooperative control method for the distributed energy resources of the virtual power plant, through self-organizing aggregation of the agents, optimized combination and cooperative control over the energy resources can be realized, overall regulation and control cost can be reduced, and the operation efficiency of the virtual power plant can be obviously improved. Moreover, a multi-level self-organizing aggregation method of the virtual power plant is provided, offering an underlying mechanism for revealing an emergence mechanism of a system. In addition, a method for realizing self-organizing aggregation of the adaptive agents is provided such that an optimal joint action and gains of an adaptive agent combination can be quickly and accurately solved, a convergence process of self-organizing aggregation can be accelerated, and overall decision-making efficiency can be improved.

### CROSS REFERENCE TO RELATED APPLICATION(S)

This patent application claims the benefit and priority of Chinese Patent Application No. 202011278673.5 filed on Nov. 16, 2020, the disclosure of which is incorporated by reference herein in its entirety as part of the present application.

### TECHNICAL FIELD

The present disclosure relates to the technical field of electrical engineering and automation, and particularly to a self-organizing aggregation and cooperative control method for distributed energy resources of a virtual power plant.

### BACKGROUND ART

In existing cooperative control methods for distributed energy resources, one studies interaction of the distributed energy resources from the perspective of game theory, and another uses a distributed cooperative control method to realize mutual cooperation of the distributed energy resources.

The existing methods have the following shortcomings: (1) most methods only focus on “steady state” conditions of final convergence of a system, and it is assumed that the distributed energy resources have complete information and complete rationality, the most methods will change their actions actively when the system is unbalanced so as to jointly push the system to a steady state; and (2) a dynamic process of interaction of the distributed energy resources is not sufficiently described in the existing methods, and individual states and actions and environmental characteristics are not integrated organically, so it is difficult to reveal an emergence mechanism of a qualitative change of the system.

Based on the above problems, the solution provides a self-organizing aggregation and cooperative control method for distributed energy resources of a virtual power plant.

### SUMMARY

An object of the present disclosure is to provide a self-organizing aggregation and cooperative control method for distributed energy resources of a virtual power plant, mutual cooperation between various adaptive agents is realized by the self-organizing aggregation, and all of the agents as a whole are driven to evolve to save energy, reduce consumption, and improve overall operation efficiency of the virtual power plant. Finally, dynamic coupling and cooperative control for the massive, distributed energy resources are realized.

In order to realize the above objects, the present disclosure provides the following technical solution: the self-organizing aggregation and cooperative control method for distributed energy resources of a virtual power plant includes:

Step 1: defining basic rules of self-organizing aggregation of adaptive agents;

Taking two agents as an example, defining:

Rule 1: minimum fitness aggregation:

min{μ_{A},μ_{B}}<min{μ_{A}^{A,B},μ_{B}^{A,B}} (1),

where μ_{A} and μ_{B} represent environmental fitness of A and B before aggregation respectively, and μ_{A}^{A,B} and μ_{B}^{A,B} represent environmental fitness of A and B after aggregation respectively;

Rule 2: maximum fitness aggregation:

min{μ_{A},μ_{B}}<max{μ_{A}^{A,B},μ_{B}^{A,B}} (2),

which indicates that after aggregation, an individual with maximum fitness is improved;

Rule 3: average fitness aggregation:

avg{μ_{A},μ_{B}}<avg{μ_{A}^{A,B},μ_{B}^{A,B}} (3),

which indicates that after aggregation, overall average fitness is improved; and

Rule 4: custom fitness aggregation:

f_{μ}{μ_{A},μ_{B}}<f_{μ}{μ_{A}^{A,B},μ_{B}^{A,B}} (4),

where f_{μ} is a certain custom function of fitness, and indicates that after aggregation, the adaptive agents are improved in a given direction.

On the basis of the basic rules, the adaptive agents may be aggregated from simple individuals into complex individuals, that is, Meta-Agents.

Step 2: constructing a dynamic self-organizing hierarchical structure of the adaptive agents;

On the basis of the four rules, the adaptive agents may be aggregated from simple individuals into complex individuals, referred as the Meta-Agents in Central Authentication Service (CAS). At the moment, interaction between the Meta-Agents and interaction between the Meta-Agents and environment are changed, and the Meta-Agents continue to be aggregated to form larger agents, such that the hierarchical structure aggregated step by step from bottom to top is formed.

Assuming that the virtual power plant is an m-level structure formed by self-organizing the adaptive agents, then:

$$\{ \begin{matrix}L ( vpp ) = 〈 L ( 0 ) , L ( 1 ) , … , L ( m ) 〉 \\ \{ x \vert x ∈ L ( i ) \} ⊆ \{ x \vert x ∈ L ( i - 1 ) \}\end{matrix} , \qquad ( 5 )$$

where L(i) represents a structure at the i-th level, which is an aggregate formed, according to certain rules, by the adaptive agents at a lower level L(i−1), and x represents a certain adaptive agent in a level; and

defining an aggregation rule R(i) of the i-th level as:

$$R ( i ) \text{:} {\sum }_{k = 1}^{4} {λ}_{k} R u l {e}_{k} , \qquad ( 6 )$$

where Ruleᵢ represents the i-th rule, λₖ represents a weight coefficient of the k-th rule, a value range of the weight coefficient is [0, 1], and an algebraic sum is 1.

Step 3, realizing, by observing and training the dynamic self-organizing hierarchical structure of agents, optimized combination and cooperative control of the energy resources of the virtual power plant.

When the distributed energy resources are aggregated in a self-organizing manner from bottom to top, the virtual power plant itself may be regarded as an adaptive agent formed by several-level aggregation of the distributed energy resources, and the levels and combination modes are dynamically varied. The degree of flexibility of the virtual power plant depends on methods of connection, coupling, and adaption of inferior individuals. Therefore, an optimization problem with respect to control over the distributed energy resources by the virtual power plant is transformed into a simulation problem of multi-agent cooperative evolution. In other words, a goal of cooperative control over the distributed energy resources is realized by observing an evolution process of the distributed energy resources.

Compared with the prior art, the present disclosure has the beneficial effects:

(1) With self-organizing aggregation of the agents, optimized combination and cooperative control over the energy resources may be realized, overall regulation and control cost may be reduced, and the operation efficiency of the virtual power plant may be obviously improved;

(2) A multi-level self-organizing aggregation method of the virtual power plant is provided, offering an underlying mechanism for revealing an emergence mechanism of a system; and

(3) A method for realizing self-organizing aggregation of the adaptive agents is proposed such that an optimal joint action and gains of an adaptive agent combination may be quickly and accurately resolved, a convergence process of self-organizing aggregation may be accelerated, and overall decision-making efficiency may be enhanced.

### BRIEF DESCRIPTION OF THE DRAWINGS

For the purpose of describing the technical solutions in the embodiments of the present disclosure more clearly, the accompanying drawings required for describing the embodiments are briefly described below. Obviously, the accompanying drawings in the following description show merely some embodiments of the present disclosure, and a person of ordinary skill in the art would also be able to derive other accompanying drawings from these accompanying drawings without creative efforts.

FIG. 1 is a schematic diagram of cooperative evolution of adaptive agents in the present disclosure;

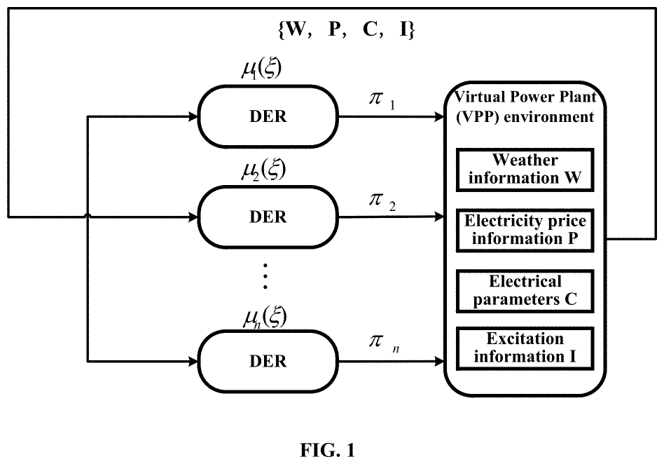

FIG. 2 is a multi-level self-organizing architecture of the adaptive agents in the present disclosure;

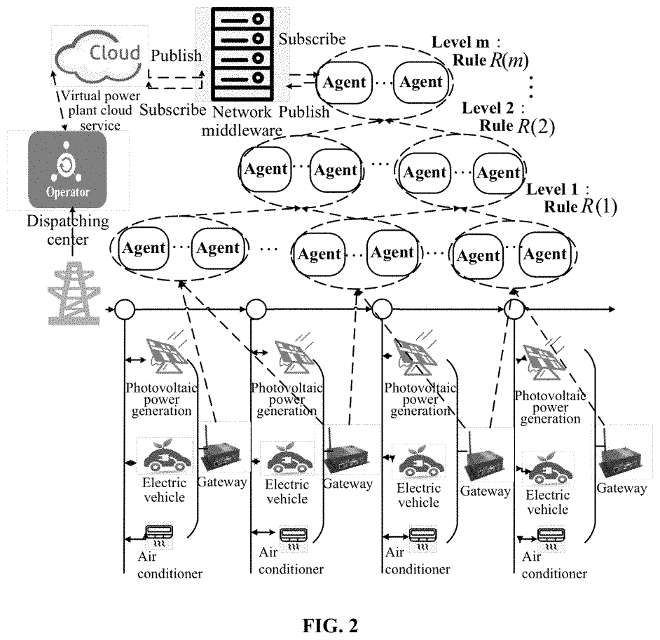

FIG. 3 is a process of QMIX-based self-organizing aggregation training of the adaptive agents; and

FIG. 4 is a flow of QMIX-based online self-organizing aggregation of the adaptive agents.

### DETAILED DESCRIPTION OF THE EMBODIMENTS

The technical solutions of the embodiments of the present disclosure are clearly and completely described below with reference to the accompanying drawings. Obviously, the described embodiments are merely a part rather than all of the embodiments of the present disclosure. All other embodiments obtained by a person of ordinary skill in the art on the basis of the embodiments of the present disclosure without creative efforts shall fall within the protection scope of the present disclosure.

Step 1: Construction of Multi-Agent Cooperative Evolution Model

A fitness measure function of adaptive agents is constructed based on levelized cost of electricity, defined as:

$${μ}_{A}^{π} ( ξ ) = \frac{1}{f ( A )} = \frac{E}{( B + C + L + ɛ ) - R} , \qquad ( 1 )$$

where E represents power consumption of the adaptive agents in a certain period, B represents power generation gains in the period, and B=E·P_{c}, P_{c} representing an electricity price in the period; C represents regulation and control cost, where a value of the regulation and control cost and a regulation and control amount are in a strictly convex function relation; L represents cost of operation and maintenance, punishment, etc.; R represents a reward of the environment; ε represents a relatively large positive constant to ensure that a denominator is not less than 0; and f(A) represents the levelized cost of electricity of the adaptive agents in a certain period, and for the convenience of understanding, a reciprocal of the levelized cost of electricity is taken such that the lower the levelized cost of electricity, the greater the fitness.

Step 2: Self-Organizing Aggregation Optimization Based on QMIX Algorithm

2.1 Self-Organizing Process Based on Markov Game

A state change of the distributed energy resources only depends on a state and an action in the current period, such that evolution of the adaptive agents is a Markov process;

Self-organizing aggregation of the adaptive agents is described by Markov Game, a process of which is defined by a quintuple as follows:

<N,S,A₁, . . . ,Aₙ,T,R₁, . . . Rₙ> (7),

where N={1, 2, . . . , n} represents n adaptive agents; S represents a joint state space of an adaptive agent combination; Aᵢ represents an action space of the i-th adaptive agent; T represents a state transition matrix of a joint action; and Rᵢ represents gains obtained by the i-th adaptive agent.

2.2 Goal of Multi-Agent Reinforcement Learning

A goal of multi-agent reinforcement learning may be expressed as follows:

$$\{ \begin{matrix}\begin{matrix}{\sum }_{{a}_{1} , … , {a}_{n} ∈ {A}_{1} \times ⋯ \times {A}_{n}} Q * ( s , {a}_{1} , ⋯ , {a}_{n} ) {π}_{1}^{*} ( s , {a}_{1} ) ⋯ {π}_{n}^{*} ( s , {a}_{n} ) \geq {\sum }_{{a}_{1} , ⋯ , {a}_{n} ∈ {A}_{1} \times ⋯ \times {A}_{n}} {Q}_{i} ( s , {a}_{1} , ⋯ , {a}_{n} ) {π}_{1} ( s , {a}_{1} ) ⋯ {π}_{n} ( s , {a}_{n} ) \\ {V}_{i}^{*} ( s ) = {\sum }_{{a}_{1} , ⋯ , {a}_{n} ∈ {A}_{1} \times ⋯ \times {A}_{n}} {Q}_{i}^{*} ( s , {a}_{1} , ⋯ , {a}_{n} ) {π}_{1}^{*} ( s , {a}_{1} ) ⋯ {π}_{n}^{*} ( s , {a}_{n} )\end{matrix} \\ {Q}_{i}^{*} ( s , {a}_{1} , ⋯ , {a}_{n} ) = {\sum }_{{s}^{′} ∈ S} Tr ( s , {a}_{1} , ⋯ , {a}_{n} , {s}^{′} ) [ {R}_{i} ( s , {a}_{1} , ⋯ , {a}_{n} , {s}^{′} ) + γ {V}_{i}^{*} ( {s}^{′} )\end{matrix} , \qquad ( 8 )$$

where s∈S represents a certain state combination after the adaptive agents are combined; πᵢ(s,aᵢ) represents that an action of the i-th adaptive agent employing, under the condition that the state is S, a strategy πᵢ is aᵢ; Vᵢ(s) is a state value function of the i-th combination under the condition that the state is s; Qᵢ(s) is an action value function under the state; and in a problem of self-organizing aggregation of the distributed energy resources, an Q value is an algebraic sum of individual fitness in an organization, that is

$${\sum }_{i = 1}^{n} {μ}_{i} ( E ) ,$$

a symbol ‘*’ represents a theoretical optimal value of the value, and γ is a discount factor.

2.3 QMIX Algorithm and Training Process

QMIX is an efficient value function decomposition algorithm proposed by Tabish Rashid, which, on the basis of a Value-Decomposition Network (VDN), merges local value functions of the adaptive agents through a mixing network, and adds global state information in a training process to assist in improving performance of the algorithm.

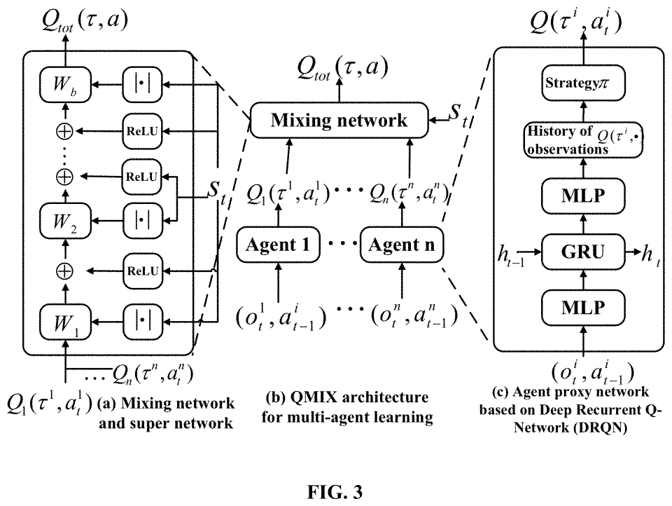

As shown in FIG. 3, the training process based on the QMIX algorithm mainly includes: adaptive agent proxy network training based on a Deep Recurrent Q-Network (DRQN) and global training based on the mixing network.

1) Adaptive Agent Proxy Network Training Based on DRQN

Firstly, the DRQN is used to solve decision behaviors and Q values of the adaptive agents under partially observable conditions, where one single adaptive agent cannot obtain a complete global state, which is a partially observable Markov decision-making process, and basic functions of the algorithm can be expressed as follows:

(oₜⁱ,aₜ₋₁ⁱ)⇒Qᵢ(τⁱ,aₜⁱ) (9),

a current observation oₜⁱ, namely, actions taken by the other adaptive agents in a combination, and its own action aₜ₋₁ⁱ at a previous moment are input to obtain an action aₜⁱ and an Q value at a current moment, and they are recorded as samples, where τⁱ=(a₀ⁱ,o₁ⁱ, . . . , aₜ₋₁ⁱ,oₜⁱ) represents a sample record of action-observation of the i-th adaptive agent from an initial state; and

On the basis of the structure of a Deep Q-Network (DQN), a fully-connected layer of the last layer of a convolutional layer with a variant gate recurrent unit (GRU) of a long short term memory (LSTM) model is replaced by the DRQN, and state parameters of a hidden layer in a period t are recorded by hₜ.

2) Global Training Based on Mixing Network

A distributed strategy is obtained by QMIX through a centralized learning method, where a training process of a joint action value function does not record aₜⁱ value of each adaptive agent, as long as it is ensured that an optimal action executed on a joint value function and an optimal action set executed on each adaptive agent produce the same result:

$$arg max {Q}_{t o t} ( τ , a ) = ( \begin{matrix}arg max {Q}_{1} ( {τ}^{1} , {a}^{1} ) \\ ⋮ \\ arg max {Q}_{n} ( {τ}^{n} , {a}^{n} )\end{matrix} ) , \qquad ( 10 )$$

where arg max Qᵢ represents a maximum Q value of an action value function of the i-th adaptive agent; arg max Qₜₒₜ represents a maximum Q value of the joint value function; in this way, each adaptive agent only needs to use, in the training process, a greedy strategy to select the action aⁱ to maximize arg max Qᵢ to participate in a decentralized decision-making process;

To make the equation (10) hold, it is converted into a monotonicity constraint by the QMIX and implemented through the mixing network:

$$\frac{\partial {Q}_{tot}}{\partial {Q}_{i}} \geq 0 ∀ i ∈ \{ 1 , 2 , ⋯ , n \} , \qquad ( 11 )$$

where basic functions of the mixing network may be expressed as:

$$\{ \begin{matrix}\{ {Q}_{i} ( {τ}^{i} , {a}_{t}^{i} ) \} & & \\ & ⇒ & \{ \begin{matrix}\begin{matrix}\{ {W}_{j} \} \\ \end{matrix} \\ b\end{matrix} \\ {s}_{t} & & \end{matrix} , \qquad ( 12 )$$

that is, the optimal action aₜⁱ taken by each adaptive agent in the period t, the Q value and the state Sᵢ of the system are input in the mixing network, and a weight Wⱼ and an offset b of the mixing network are output; and in order to ensure that the weight is non-negative, a linear network and an absolute value activation function are used to ensure that an output value is non-negative, and the offset of the last level of the mixing network uses a two-level network and a rectified linear unit (ReLU) activation function to obtain a nonlinear mapping network; and

A global training loss function of QMIX is:

$$L ( θ ) = [ {\sum }_{i = 1}^{m} {( {y}_{i}^{tot} - {Q}_{tot} ( τ , a , s , θ ) )}^{2} ] , \qquad ( 13 )$$

where yᵢ^{tot} represents the i-th global sample, and θ represents network parameters.

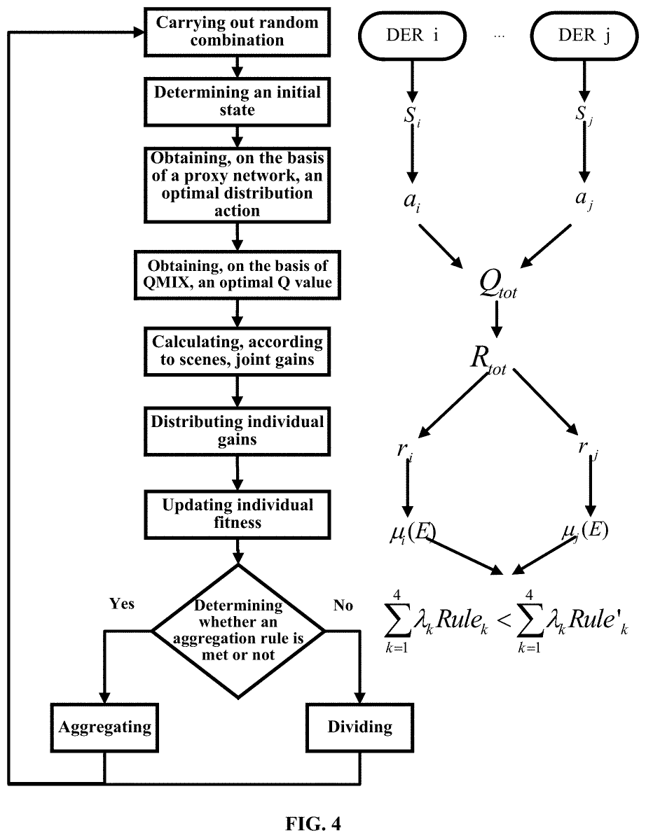

With the above centralized training method, when it is determined whether the adaptive agent combination is “fused” or “divided”, the maximum fitness of the combination and the corresponding optimal joint action may be quickly obtained; and a basic flow of online self-organizing aggregation of the adaptive subjects is shown in FIG. 4.

In the forgoing description of the present disclosure, reference to terms “one embodiment”, “examples”, “specific examples”, and the like means that a specific feature, structure, material, or characteristic described in combination with the embodiment are included in at least one embodiment or example of the present disclosure. In the description, the schematic descriptions of the above terms do not necessarily refer to the same embodiment or example. Moreover, the specific feature, structure, material, or characteristics described may be combined in a suitable manner in any one or more embodiments or examples.

The preferred embodiments of the present disclosure disclosed above are only used to help illustrate the present disclosure. The preferred embodiments neither describe all the details in detail, nor limit the present disclosure to the specific embodiments described. Obviously, a plurality of modifications and changes can be made according to the content of the description. The description selects and specifically describes these embodiments, in order to better explain the principle and practical application of the present disclosure, so that a person skilled in the art can well understand and use the present disclosure. The present disclosure is only limited by the claims, full scope thereof and equivalents.

What is claimed is:

1. A self-organizing aggregation and cooperative control method for distributed energy resources of a virtual power plant, comprising:
step 1: defining basic rules of self-organizing aggregation of adaptive agents,
wherein on the basis of the basic rules, the adaptive agents can be aggregated from simple individuals into complex individuals, that is, Meta-Agents;
step 2: constructing a dynamic self-organizing hierarchical structure of the adaptive agents,
wherein on the basis of step 1, interaction between the Meta-Agents and interaction between the Meta-Agents and environment are changed, and aggregation rules are designed, such that the Meta-Agents continue to be aggregated to form larger agents, and the hierarchical structure aggregated step by step from bottom to top is formed; and
step 3, realizing, by observing and training the dynamic self-organizing hierarchical structure of the agents, optimized combination and cooperative control of the energy resources of the virtual power plant.

2. The self-organizing aggregation and cooperative control method for distributed energy resources of a virtual power plant according to claim 1, wherein
step 1 of defining basic rules of self-organizing aggregation of adaptive agents, for example, two agents, comprises: defining
rule 1: minimum fitness aggregation:
min{μ_{A},μ_{B}}<min{μ_{A}^{A,B},μ_{B}^{A,B}} (1),
where μ_{A} and μ_{B} represent environmental fitness of A and B before aggregation respectively, and μ_{A}^{A,B} and μ_{B}^{A,B} represent environmental fitness of A and B after aggregation respectively;
rule 2: maximum fitness aggregation:
min{μ_{A},μ_{B}}<max{μ_{A}^{A,B},μ_{B}^{A,B}} (2),
which indicates that after aggregation, an individual with maximum fitness is improved;
rule 3: average fitness aggregation:
avg{μ_{A},μ_{B}}<avg{μ_{A}^{A,B},μ_{B}^{A,B}} (3),
which indicates that after aggregation, overall average fitness is improved; and
rule 4: custom fitness aggregation:
f_{μ}{μ_{A},μ_{B}}<f_{μ}{μ_{A}^{A,B},μ_{B}^{A,B}} (4),
wherein f_{μ} is a certain custom function of fitness, and indicates that after aggregation, the adaptive agents are improved in a given direction.

3. The self-organizing aggregation and cooperative control method for distributed energy resources of a virtual power plant according claim 2, wherein
step 2 of designing the aggregation rules comprises:
assuming that the virtual power plant is an m-level structure formed by self-organizing the adaptive agents, obtaining
$$\{ \begin{matrix}L ( v p p ) = 〈 L ( 0 ) , L ( 1 ) , ⋯ , L ( m ) 〉 \\ \{ x \vert x ∈ L ( i ) \} ⊆ \{ x \vert x ∈ L ( i - 1 ) \}\end{matrix} , \qquad ( 5 )$$
wherein L(i) represents a structure at an i-th level which is an aggregate formed, according to certain rules, by the adaptive agents at a lower level L(i−1), and x represents a certain adaptive agent in a level; and
defining an aggregation rule R(i) of the i-th level as
$$R ( i ) : {\sum }_{k = 1}^{4} {λ}_{k} R u l {e}_{k} , \qquad ( 6 )$$
wherein Ruleᵢ represents the i-th rule, λₖ represents a weight coefficient of the k-th rule, a value range of the weight coefficient is [0, 1], and an algebraic sum is 1.

4. The self-organizing aggregation and cooperative control method for distributed energy resources of a virtual power plant according claim 3, wherein
in step 1, on the basis of levelized cost of electricity, a fitness measure function of the adaptive agents is constructed, defined as:
$${μ}_{A}^{π} ( ξ ) = \frac{1}{f ( A )} = \frac{E}{( B + C + L + ɛ ) - R} , \qquad ( 1 )$$
wherein E represents power consumption of the adaptive agents in a certain period, B represents power generation gains in the period, and B=E·P_{c}, P_{c} representing an electricity price in the period; C represents regulation and control cost, wherein a value of the regulation and control cost and a regulation and control amount are in a strictly convex function relation; L represents cost of operation and maintenance, punishment, etc.; R represents a reward of the environment; ε represents a relatively large positive constant to ensure that a denominator is not less than 0; and f(A) represents the levelized cost of electricity of the adaptive agents in a certain period, and for the convenience of understanding, a reciprocal of the levelized cost of electricity is taken such that the lower the levelized cost of electricity, the greater the fitness.

5. The self-organizing aggregation and cooperative control method for distributed energy resources of a virtual power plant according claim 4, wherein self-organizing aggregation of the adaptive agents is described by Markov Game, a process of which is defined by the following quintuple:
<N,S,A₁, . . . ,Aₙ,T,R₁, . . . Rₙ> (7),
where N={1, 2, . . . , n} represents n adaptive agents; S represents a joint state space of an adaptive agent combination; Aᵢ represents an action space of the i-th adaptive agent; T represents a state transition matrix of a joint action; and Rᵢ represents gains obtained by the i-th adaptive agent.

6. The self-organizing aggregation and cooperative control method for distributed energy resources of a virtual power plant according claim 5, wherein a goal of multi-agent reinforcement learning can be expressed as follows:
$$\{ \begin{matrix}\begin{matrix}{\sum }_{{a}_{1} , … , {a}_{n} ∈ {A}_{1} \times ⋯ \times {A}_{n}} Q * ( s , {a}_{1} , ⋯ , {a}_{n} ) {π}_{1}^{*} ( s , {a}_{1} ) ⋯ {π}_{n}^{*} ( s , {a}_{n} ) \geq {\sum }_{{a}_{1} , ⋯ , {a}_{n} ∈ {A}_{1} \times ⋯ \times {A}_{n}} {Q}_{i} ( s , {a}_{1} , ⋯ , {a}_{n} ) {π}_{1} ( s , {a}_{1} ) ⋯ {π}_{n} ( s , {a}_{n} ) \\ {V}_{i}^{*} ( s ) = {\sum }_{{a}_{1} , ⋯ , {a}_{n} ∈ {A}_{1} \times ⋯ \times {A}_{n}} {Q}_{i}^{*} ( s , {a}_{1} , ⋯ , {a}_{n} ) {π}_{1}^{*} ( s , {a}_{1} ) ⋯ {π}_{n}^{*} ( s , {a}_{n} )\end{matrix} \\ {Q}_{i}^{*} ( s , {a}_{1} , ⋯ , {a}_{n} ) = {\sum }_{{s}^{′} ∈ S} Tr ( s , {a}_{1} , ⋯ , {a}_{n} , {s}^{′} ) [ {R}_{i} ( s , {a}_{1} , ⋯ , {a}_{n} , {s}^{′} ) + γ {V}_{i}^{*} ( {s}^{′} )\end{matrix} , \qquad ( 8 )$$
wherein s∈S represent a certain state combination after the adaptive agents are combined; πᵢ(s,aᵢ) represent that an action of the i-th adaptive agent employing, under the condition that the state is s, a strategy πᵢ is aᵢ; Vᵢ(s) is a state value function of the i-th combination under the condition that the state is s; Qᵢ(s) is an action value function under the state; and in a problem of self-organizing aggregation of the distributed energy resources, a Q value is an algebraic sum of individual fitness in an organization, that is
$${\sum }_{i = 1}^{n} {μ}_{i} ( E ) ,$$
* represents a theoretical optimal value of the value, and γ is a discount factor.

7. The self-organizing aggregation and cooperative control method for distributed energy resources of a virtual power plant according claim 6, wherein in step 3, training the adaptive agents by using the QMIX algorithm mainly comprises: adaptive agent proxy network training based on a Deep Recurrent Q-Network (DRQN) and global training based on a mixing network.

8. The self-organizing aggregation and cooperative control method for distributed energy resources of a virtual power plant according claim 7, wherein a process of adaptive agent proxy network training based on a DRQN is as follows:
firstly, using the DRQN to solve decision actions and Q values of the adaptive agents under partially observable conditions, wherein one single adaptive agent cannot obtain a complete global state, which is a partially observable Markov decision process, and basic functions of the algorithm can be expressed as follows:
(oₜⁱ,aₜ₋₁ⁱ)⇒Qᵢ(τⁱ,aₜⁱ) (9),
inputting a current observation oₜⁱ, namely, actions taken by the other adaptive agents in a combination, and its own action aₜ₋₁ⁱ at a previous moment, to obtain an action aₜⁱ and a Q value at a current moment, and recording them as samples, wherein τⁱ=(a₀ⁱ,o₁ⁱ, . . . , aₜ₋₁ⁱ, oₜⁱ) represents a sample record of action-observation of the i-th adaptive agent from an initial state; and
replacing by the DRQN, on a structure of a Deep Q-Network (DQN), a fully-connected layer of the last layer of a convolutional layer with a variant gate recurrent unit (GRU) of a long short term memory (LSTM) model, and recording, by hₜ, state parameters of a hidden layer in a period t.

9. The self-organizing aggregation and cooperative control method for distributed energy resources of a virtual power plant according claim 8, wherein a process of global training based on a mixing network is as follows:
obtaining a distributed strategy by QMIX through a centralized learning method, wherein a training process of a joint action value function does not record a aₜⁱ value of each of the adaptive agents, as long as it is ensured that an optimal action executed on a joint value function and an optimal action set executed on each of the adaptive agents produce the same result:
$$arg max {Q}_{t o t} ( τ , a ) = ( \begin{matrix}arg max {Q}_{1} ( {τ}^{1} , {a}^{1} ) \\ ⋮ \\ arg max {Q}_{n} ( {τ}^{n} , {a}^{n} )\end{matrix} ) , \qquad ( 10 )$$
wherein arg max Qᵢ represents a maximum Q value of an action value function of the i-th adaptive agent; arg max Qₜₒₜ represents a maximum Q value of the joint value function; in this way, each adaptive agent only needs to use, in the training process, a greedy strategy to select the action aᵢ to maximize arg max Qᵢ to participate in a distributed decision-making process;
converting it into a monotonicity constraint by the QMIX to make the equation (10) hold and implementing through the mixing network:
$$\frac{\partial {Q}_{tot}}{\partial {Q}_{i}} \geq 0 ∀ i ∈ \{ 1 , 2 , ⋯ , n \} ; \qquad ( 11 )$$
wherein basic functions of the mixing network can be expressed as:
$$\{ \begin{matrix}\{ {Q}_{i} ( {τ}^{i} , {a}_{t}^{i} ) \} & & \\ & ⇒ & \{ \begin{matrix}\begin{matrix}\{ {W}_{j} \} \\ \end{matrix} \\ b\end{matrix} \\ {s}_{t} & & \end{matrix} , \qquad ( 12 )$$
that is, the optimal action aₜⁱ taken by each adaptive agent in the period t, the Q value and a state Sₜ of a system are input into the mixing network, and a weight Wⱼ and an offset b of the mixing network are output; and in order to ensure that the weight is non-negative, a linear network and an absolute value activation function are used to ensure that an output value is non-negative, and the offset of a last level of the mixing network uses a two-level network and a rectified linear unit (ReLU) activation function to obtain a nonlinear mapping network; and
a global training loss function of QMIX is:
$$L ( θ ) = [ {\sum }_{i = 1}^{m} {( {y}_{i}^{tot} - {Q}_{tot} ( τ , a , s , θ ) )}^{2} ] , \qquad ( 13 )$$
wherein yᵢ^{tot} represents the i-th global sample, and θ represents network parameters; and
through the above centralized training method, when it is determined whether any adaptive agent combination is “fused” or “divided”, the maximum fitness of the combination and the corresponding optimal joint action can be quickly obtained.
